(19) United States
(12) Patent Application Publication
(10) Pub. No.: US 2005/0102279 A1
(43) Pub. Date: May 12, 2005

(54) Method of and apparatus for acquiring information and computer program

(75) Inventor: Masami Watanabe, Shizuoka (JP)

Correspondence Address: Patrick G. Burns, Esq.;GREER, BURNS & CRAIN, LTD., Suite 2500, 300 South Wacker Dr., Chicago, IL, 60606, US

(73) Assignee: JUJITSU LIMITED

(21) Appl. No.: 10/851,496

(22) Filed: May 21, 2004

(30) Foreign Application Priority Data
Nov. 11, 2003 (JP) 2003-381712

(51) Int. Cl. G06F 7/00

(52) U.S. Cl. 707/3

(57) ABSTRACT

An information-acquiring apparatus includes a search unit that performs search or browsing of a first web-page by issuing a request for acquiring information to a web archive, an embedding unit that embeds an address of a web-archiving server having the web archive in a uniform resource locator of a linked web-page specified in the first web-page, and an acquiring unit that acquires the linked web-page from the web archive by issuing a request for acquiring the linked web-page to the web-archiving server based on the address.

### BACKGROUND OF THE INVENTION

1) Field of the Invention

The present invention relates to a technology to acquire a desired web-page that is linked to various types of web-pages stored in a web archive.

2) Description of the Related Art

Today's internet offers various kinds of information some of which may disappear by being changed or moved. Recently, some of the developed countries have started to experimentally perform an activity of gathering, storing, and permanently saving such information on the internet to preserve the cultural property

For example, the following two literatures present a web-archiving system with which one can gather web-pages via the network and store the web-pages in a web archive. In a technology presented in “Web Archiving Project (WARP) by National Diet Library” (http://warp.ndl.go.jp/), a web-page is stored in a web archive, and an address of a linked web-page specified in the web-page is rewritten so that the linked web-page is stored in the web archive. In a technology presented in “Way Back Machine” (http://www.archive.org/), when a linked web-page is referred, the web browser rewrites a uniform resource locator (URL) of the linked web-page, which is described in an HTML file, by adding a fixed “Java Script” at the end of the HTML file. Consequently, even if the web-page disappears from the Internet, the contents of the web-page are stored in the web archive.

However, in the conventional technologies, it is not possible to trace the link that exists in various types of web-pages stored in the web archive. To jump to a linked web-page from a web-page stored in the web archive, rewriting the address (URL) of the linked web-page, which is described inside the web-page, is required. Since the conventional web-archiving system only can rewrite a link statically described in the HTML file that can be analyzed and rewritten, it is not possible to jump to a related web-page from an HTML file using “Java (trademark) Script” or a web-page other than the HTML file.

In other words, since it is not possible to analyze and rewrite a link in such web-page as a various types of word process documents, data for a various types of applications, or multimedia on the internet, proper tracing of a link in a web page stored in the web archive. Furthermore, even with a link described in an HTML file, it is not possible to analyze and rewrite the link if the link is dynamically generated by various scripts.

### SUMMARY OF THE INVENTION

It is an object of the present invention to solve at least the problems in the conventional technology.

The information-acquiring apparatus according to one aspect of the present invention includes a search unit that performs search or browsing of a first web-page by issuing a request for acquiring information to a web archive; an embedding unit that embeds an address of a web-archiving server having the web archive in a uniform resource locator of a linked web-page specified in the first web-page; and an acquiring unit that acquires the linked web-page from the web archive by issuing a request for acquiring the linked web-page to the web-archiving server based on the address.

The information-acquiring method according to another aspect of the present invention includes performing search or browsing of a first web-page by issuing a request for acquiring information to a web archive; embedding an address of a web-archiving server having the web archive in a uniform resource locator of a linked web-page specified in the first web-page; and acquiring the linked web-page from the web archive by issuing a request for acquiring the linked web-page to the web-archiving server based on the address.

The computer program for acquiring information, according to still another aspect of the present invention realizes the method according to the above aspect on a computer.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block-diagram of a web-archiving system according to a first embodiment of the present invention;

FIG. 2 is a schematic of an information-acquiring apparatus according to the present invention;

FIG. 3 is a table of an example of information stored in a management-information database;

FIG. 4 is an example of a screen displayed on an output unit (screen 1);

FIG. 5 is an example of a screen displayed on an output unit (screen 2);

FIG. 6 is an example of a screen displayed on an output unit (screen 3);

FIG. 7 is a flowchart of a generation-information holding process;

FIG. 8 is a flowchart of an information acquiring process;

FIG. 9 is a schematic of a computer system according to a second embodiment of the present invention; and

FIG. 10 is a block diagram of a main unit of the computer system shown in FIG. 9.

### DETAILED DESCRIPTION

Exemplary embodiments of a method of and an apparatus for acquiring information and a computer program according to the present invention are explained below in detail with reference to the accompanying drawings.

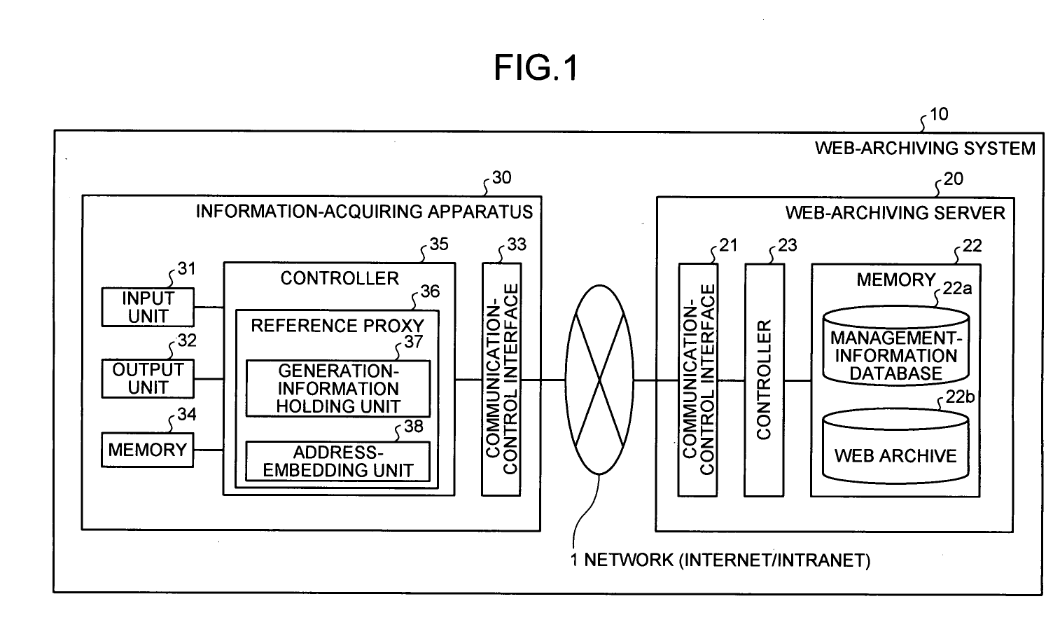

FIG. 1 is a block-diagram of a web-archiving system 10 according to a first embodiment of the present invention. The web-archiving system 10 includes a web-archiving server 20 and an information-acquiring apparatus 30, and acquires an intended web-page from a web archive 22b of the web-archiving server 20. The web-archiving server 20 and the information-acquiring apparatus 30 are connected via a network 1, such as the Internet or an intranet, to communicate each other.

A main feature of the information-acquiring apparatus 30 is an information-acquiring process, and by performing the information-acquiring process, the information-acquiring apparatus 30 can follow the links that exist in various types of web-pages stored in the web archive 22b. In the information-acquiring process,
1) the search or the browsing of the intended web-page is performed by issuing a request for acquiring an information to the web archive 22b ;
2) after the web-page is specified in the result of the search or the browsing, the web-page is referred, and the address of the web-archiving server 20 is embedded in the URL of the linked web-page specified in the web-page that is being referred;
3) the linked web-page is acquired from the web archive 22b by issuing a request for acquiring the linked web-page based on the address of the web-archiving server 20; and
4) the linked web-page is acquired.

In other words, in the information-acquiring process, the web application that refers to the web-page stored in the web archive 22b issues a web-page acquiring request, which is a request for acquiring a web-page, to the web-archiving server 20 instead of issuing an HTTP request to the Internet.

Therefore, without rewriting the URL, which the web-page stored in the web archive 22b includes, of the linked web-page, a web-page acquiring request is issued to the web archive 22b and the web-page is acquired from the web archive 22b using a conventional versatile information-acquiring function (web browser). Consequently, the links that exist in various types of web-pages stored in the web archive 22b can be followed.

In association with the main feature, the information-acquiring apparatus 30 according to the present invention has the following features:
1) the web-page gathered (hereinafter “gathered web-page”) is stored in the web archive 22b while correlating the address of the gathered web-page with the generation information of the gathered web-page;
2) when the search or the browsing of the intended web-page is performed, the generation information of the web-page specified in the result of the search or the browsing is acquired from the web archive 22b and held; and
3) the request is issued to the web-archiving server 20 to acquire the web-page and the generation information of the web-page simultaneously.

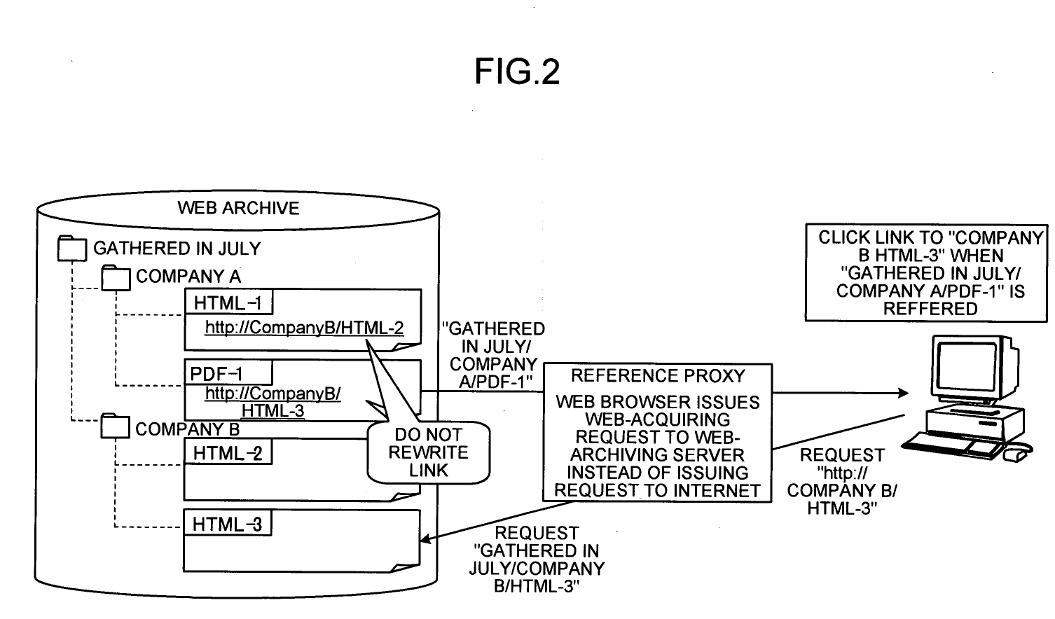

More precisely, in the web-archiving server 20, the web archive 22b, shown in FIG. 2, stores the web-page while correlating the URL (“http://CompanyB/HTML-3”) of the web-page with the generation information “gathered in July” of the web-page. When the web-page “gathered-in-July_Company-A_PDF-1” is referred using information-acquiring apparatus 30 and the web-page (“http://CompanyB/HTML-3”) that the link represents (hereinafter the “a linked web-page”) is specified in the web-page that is being referred “gathered-in-July_Company-A_PDF-1”, the information-acquiring apparatus 30 acquires the linked web-page from the web archive 22b by issuing a web-page acquiring request to the web-archiving server 20 based on the URL (“http://CompanyB/HTML-3”) of the linked web-page and the generation information “gathered in July” of the web-page that is being referred.

In this manner, when the web-page is gathered, stored in the web archive 22b, and referred, the linked web-page specified in the web-page that is being referred is acquired based on the original URL of the linked web-page, which indicates the URL of the linked web-page when the web-page that includes the link to the linked web-page is not gathered, and the generation information of the web-page that is being referred. Therefore, the link in the web-page stored in the web archive 22b can be followed without rewriting the URL of the linked web-page. Consequently, when the link exist in the application files, such as “Flash”, “Word”, “PowerPoint”, and “PDF”, or when the link is dynamically generated by script, such as “JavaScript” and “VBScript”, the link can be followed.

In the conventional technologies, the address of the linked web-page whose link exists in the web-page stored in the web archive is rewritten to be an address corresponding to the server, and the linked web-page is acquired based on the address rewritten. On the other hand, in the present invention, the linked web-page whose link exists in the web-page stored in the web archive is acquired based on the original address of the linked web-page and the generation information of the web-page. Consequently, the links that exist in various types of web-pages stored in the web archive can be followed precisely.

Moreover, in the present invention, an intended web-page is specified and acquired precisely by holding the gathering date of the web-page, which indicates when the web-page is gathered, as the generation information.

Referring to FIG. 1, the web-archiving server 20 includes a communication-control interface 21, a memory 22a, and a controller 23. The communication-control interface 21 controls the communication of various types of information between the web-archiving server 20 and the network 1.

The memory 22a stores data and programs that the controller 23 requires in various types of processes, and from a functional viewpoint, includes a management-information database 22a and the web archive 22b .

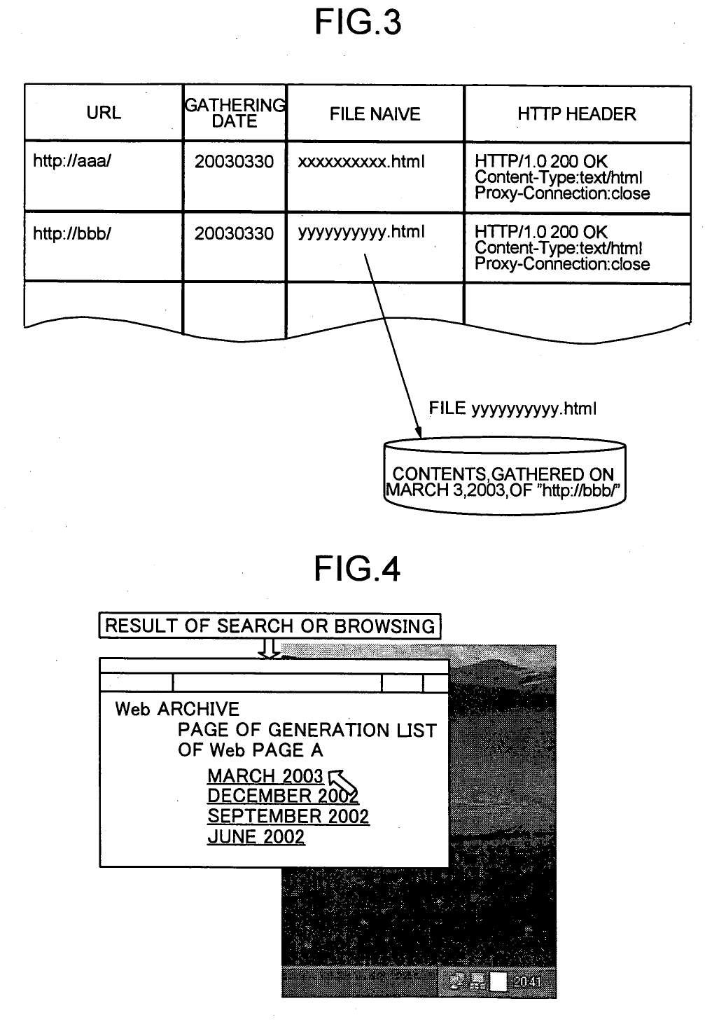

The management-information database 22a stores management information of the web archive 22b, such as the URL of gathered web-page, the gathering date, the storage location of the contents of the gathered web-page, as shown in FIG. 3.

The web archive 22b stores the contents of the web-page, which is gathered via the network 1, based on the management information stored in the management-information database 22a.

The controller 23 includes an internal memory that stores a control computer-program, programs for various types of processes and required data, and executes various types of processes (such as a process for gathering a web-page using a web robot, a process for searching the management-information database 22a in response to the web-page acquiring request from the information-acquiring apparatus 30, a process for responding to the web-page acquiring request from the information-acquiring apparatus 30).

The information-acquiring apparatus 30 includes an input unit 31, an output unit 32, a communication-control interface 33, a memory 34, and a controller 35. Examples of the information-acquiring apparatus 30 are a personal computer (PC), a personal digital assistant (PDA), a cellular phone, various kinds of mobile devices. The communication-control interface 33 controls the communication of various types of information between the information-acquiring apparatus 30 and the network 1.

The input unit 31 is a unit to input various types of information, such as a command, and examples of the input unit 31 are a keyboard, a mouse, a track ball, and the like. The input unit 31 receives:
1) the information to perform the search or the browsing of a web-page to be referred;
2) the information to select the generation information from the page that shows that generation list of the web-page as a result of the search or the browsing (see FIG. 4); and
3) the information to specify the linked web-page in the web-page that is being referred.

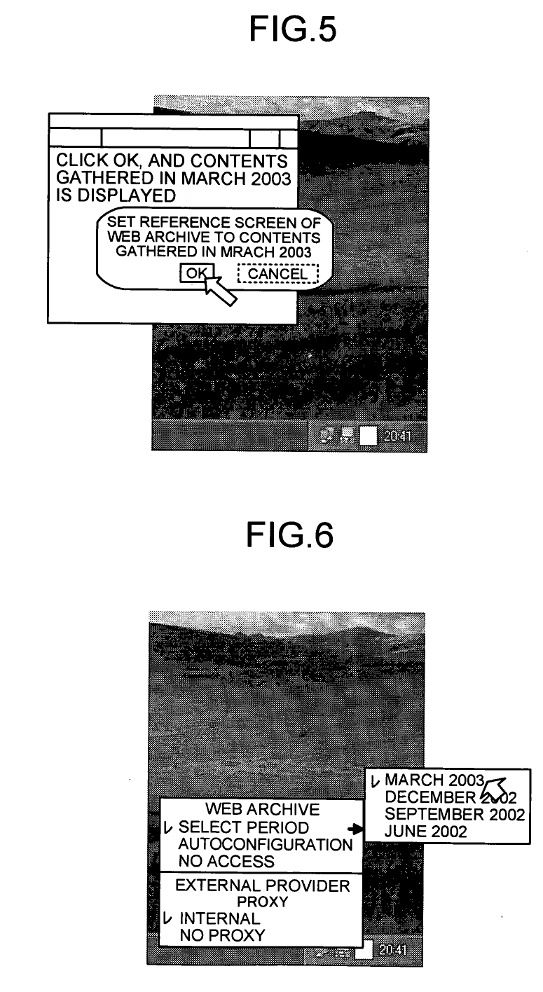

Moreover, the input unit 31 receives the information to decide whether to perform a process for holding generation information, namely whether to perform the auto-configuration of the generation to be referred (see FIG. 5).

The output unit 32 is a unit to output various types of information, and an example of the output unit 32 is a monitor. The output unit 32 outputs:
1) a screen to perform the search or the browsing of a web-page to be referred;
2) the page that shows the generation list of the web-page as a result of the search and the browsing (see FIG. 4); and
3) the web-page that a reference PROXY 36 acquires.

Moreover, the output unit 32 outputs a screen to receive the information to decide whether to perform a process for holding generation information, namely whether to perform the auto-configuration of the generation to be referred (see FIG. 5).

The memory 34 stores data and computer programs that the controller 35 and the reference PROXY 36 require in performing the processes. The memory 34 stores the contents of the web-page that the reference PROXY 36 acquires, and a computer program, which is downloaded from the web-archiving server 20, of the reference PROXY 36, a generation-information holding unit 37, and address-embedding unit 38.

The controller 35 includes an internal memory that stores control computer-programs, such as OS, computer programs for each process, and required data, and executes each process using the control computer-programs, the computer programs for each process and the data that are stored in the internal memory. From a functional viewpoint, the controller 35 includes the reference PROXY 36, the generation-information holding unit 37, and the address-embedding unit 38.

The generation-information holding unit 37 holds the generation information of the web-page that is specified in the result of the search or the browsing when the search or browsing of the web-page is performed over the web archive 32b. More precisely, when the search or the browsing of the web-page is performed, the reference PROXY 36 issues a web-page acquiring request. In response to the web-page acquiring request, an HTTP header is returned from the web-archiving server 20 with the web-page. The HTTP header includes the information “WASet-PROXY: a gathering date”. Therefore, the generation-information holding unit 37 holds the gathering date in the HTTP header as the generation information. To automatically configure the generation information of the web-page that the user refers to, the generation-information holding unit 37 is configured to hold the generation information.

The address-embedding unit 38 embeds the address of the web-archiving server 20 in the URL of the linked web-page specified in the web-page that is being referred when the generation-information holding unit 37 holds the generation information (namely in case the generation to be referred is configured automatically). More precisely, the URL of the CGI for taking the web-page (namely the URL of the web archiving sever 20) and the generation information (the gathering date) are embedded in the original URL of the linked web-page like “http://aaa/”, namely the URL of the linked web-page that has not been gathered.

Consequently, the web application that refers to the web-page stored in the web archive 22b issues the web-page acquiring request to the web-archiving server 20 instead of issuing the HTTP request to the Internet, and the web-page can be acquired from the web archive 22b using a conventional versatile information-acquiring function (web browser).

The reference PROXY 36 acts as proxy for the web browser or the web application, and acquires the web-page from the web archive 22b via the web-archiving server 20. More precisely, the reference PROXY 36 issues the web-page acquiring request to the web-archiving server 20 based on the URL that the address-embedding unit 38 embeds, and acquires the linked web-page from the web archive 22b .

In other words, the link that exists in the web-page stored in the web archive 22b can be followed without rewriting the URL of the linked web-page by acquiring the linked web-page based on the original URL of the linked web-page and the generation information of the linked web-page. Consequently, when the link exist in the application files, such as “Flash”, “Word”, “PowerPoint”, and “PDF”, or when the link is dynamically generated by script, such as “JavaScript” and “VBScript”, the link can be followed.

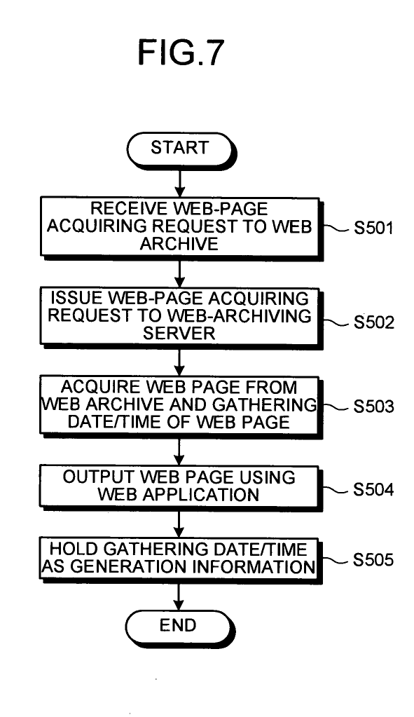

FIG. 7 is a flowchart of a generation-information holding process. The input unit 31 receives the web-page acquiring request to web archive 22b when the search or the browsing of the web-page is performed (step S501). More precisely, when the search or the browsing of the web-page is performed, the input unit 31 receives the URL of the web-page, and the information to select the generation information from the page that shows that generation list of the web-page as a result of the search or the browsing (see FIG. 4).

Then, the reference PROXY 36 acts proxy for the web browser and issues the web-page acquiring request to the web-archiving server 20 (step S502), and acquires the web-page and the gathering date of the web-page from the web archive 22b (step S503). Subsequently, the reference PROXY 36 outputs the web-page to the output unit 32 using the web application (step S504).

The generation-information holding unit 37 holds the gathering date of the web-page that the reference PROXY 36 acquires as the generation information (step S505). More precisely, when the search or the browsing of the web-page is performed, the reference PROXY 36 issues a web-page acquiring request. In response to the web-page acquiring request from, an HTTP header is returned from the web-archiving server 20 with the web-page. The HTTP header includes the information “WASet-PROXY: a gathering date”. Therefore, the generation-information holding unit 37 holds the gathering date in the HTTP header as the generation information. To automatically configure the generation information of the web-page that the user refers to, the generation-information holding unit 37 is configured to hold the generation information.

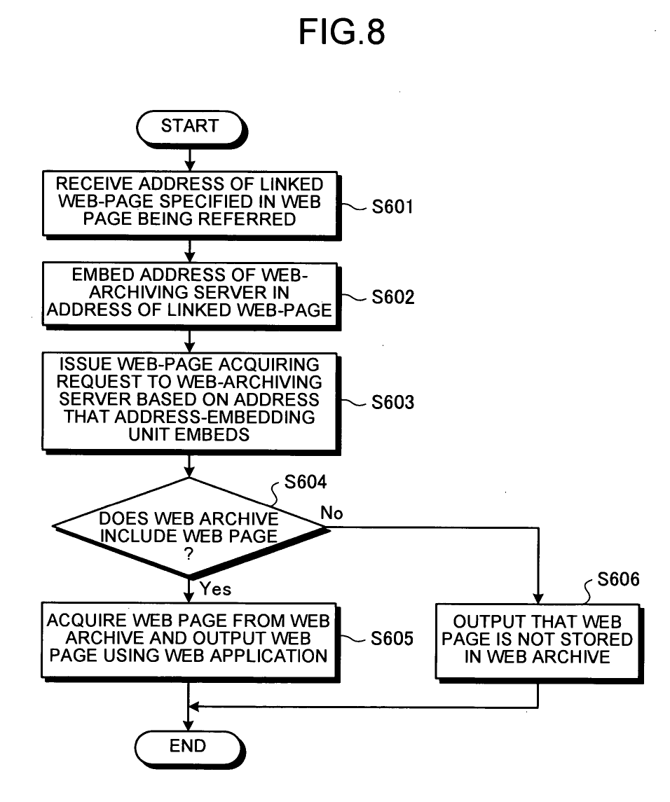

FIG. 8 is a flowchart of an information acquiring process. The input unit 31 receives the URL of the linked web-page specified in the web-page that is being referred (step S601). Then, the address-embedding unit 38 embeds the address of the web-archiving server 20 in the address (URL) of the linked web-page (step S602).

The reference PROXY 36 issues the web-page acquiring requests to the web-archiving server 20 based on the URL that the address-embedding unit 38 embeds (step S603).

If the web archive 22b includes the web-page that has the URL and the gathering date that are same as those of the web-page corresponding to the web-page acquiring request (step S604/Yes), the linked web-page is acquired from the web archive 22b and output to the output unit 32 using the web application (step S605).

If the web archive 22b does not include the web-page that has the URL and the gathering date that are same as those of the web-page corresponding to the web-page acquiring request (step S604/No), the information that indicates the web archive 22b does not includes the web-page corresponding to the web-page acquiring request is output (step S606).

In this manner, according to the information-acquiring apparatus 30 according to the first embodiment,
1) the search or the browsing of an intended web-page is performed by issuing the request for acquiring the information to the web archive 22b ;
2) after the web-page is specified in the result of the search or the browsing, the web-page is referred, and the address of the web-archiving server 20 is embedded in the URL of the linked web-page specified in the web-page that is being referred; and
3) the request for acquiring the linked web-page is issued based on the URL of the web-archiving server 20.

Consequently, without rewriting the URL, which the web-page stored in the web archive 22b includes, of the linked web-page, the web-page acquiring request is issued to the web archive 22b, and the links that exist in various types of web-pages stored in the web archive 22b can be followed.

According to the information-acquiring apparatus 30 according to the first embodiment,
1) the gathered web-page is stored in the web archive 22b while correlating the address of the gathered web-page with the generation information of the gathered web-page;
2) when the search or the browsing of the intended web-page is performed, the generation information of the web-page specified in the result of the search or the browsing is acquired from the web archive 22b and held; and
3) the request is issued to the web-archiving server 20 to acquire the web-page and the generation information of the web-page simultaneously.

Consequently, the links that exist in various types of web-pages stored in the web archive 22b can be followed, and the generation information of the web-page that the user refers to can be configured automatically.

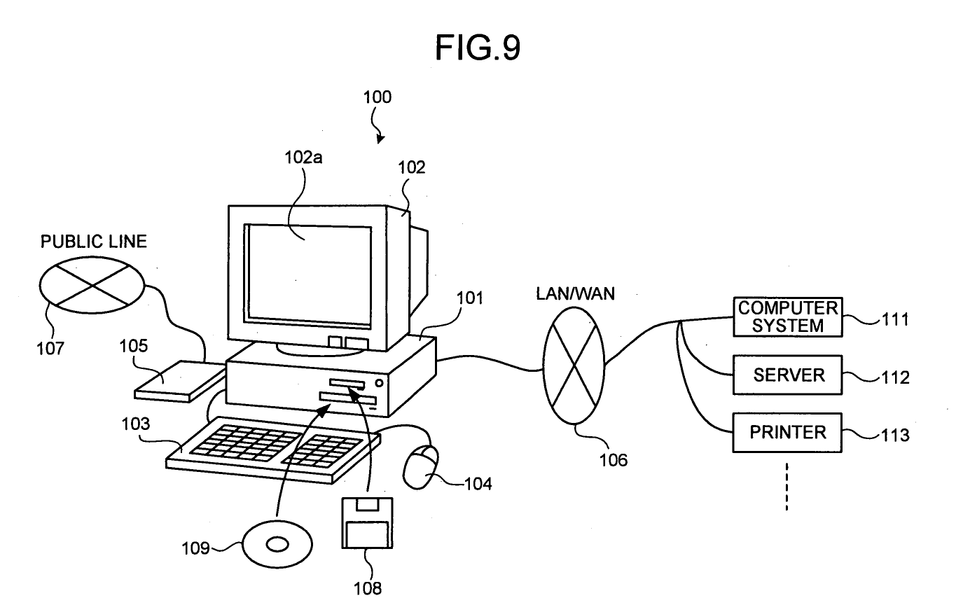

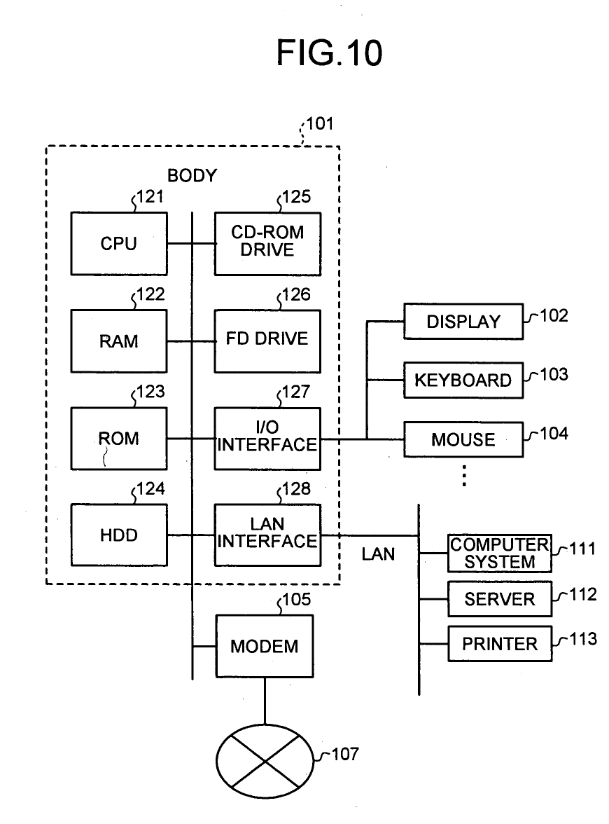

FIG. 9 is a schematic of a computer system according to a second embodiment of the present invention. The computer system 100, such as a personal computer and a workstation, executes the information-gathering computer program to realize the information acquiring system and the information acquiring apparatus (the information acquiring method) according to the first embodiment to third embodiment. FIG. 10 is a block diagram of a main unit of the computer system shown in FIG. 9. The computer system 100 includes the main unit 101, a display 102, which displays an image or the like on a screen 102a based on commands from the main unit 101, a keyboard 103, which is used to input various types of information to the computer system 100, and a mouse 104, which is used to specify any points on the screen 102a.

The main unit 101 includes a Central Processing Unit (CPU) 121, a Random Access Memory (RAM) 122, a Read Only Memory (ROM) 123, a Hard Disk Drive (HDD) 124, a Compact-Disk Read-Only-Memory drive (CD-ROM drive) 125, where a CD-ROM is inserted, a floppy disk drive (FDD) 126, where a floppy disk (FD) is inserted, an Input/Output interface (I/O interface) 127, to which the display 102, the keyboard 103, and the mouse 104 are connected, and a Local Area Network interface (LAN interface) 128, which is connected to a Local Area Network/Wide Area Network (LAN/WAN) 106.

Moreover, a modem 105, which connects the computer system 100 to a public line 107 like an internet, and another computer system 111, a server 112, and a printer 113 are connected to the main unit 101 via the LAN/WAN 106.

The computer system 100 reads the information-gathering computer program stored in a certain recoding media and executes the information-gathering computer program, so that the computer system 100 realizes the information acquiring system (information acquiring method). The examples of the recording media are the portable physical-media, such as the FD 108, the CD-ROM 109, an Magneto-Optical (MO) disk, a Digital Versatile Disk (DVD), and an Integrated Circuit (IC) card, the immovable physical-media, such as the HDD 124, which is arranged inside or outside the computer system 100, the RAM 122, and the ROM 123, the communication media, which holds the computer program temporarily during the transmission of the computer program, such as the public line 107 and the LAN/WAL 106.

In this manner, the information-gathering computer program is stored in the recording media to be computer-readable. The computer system 100 realizes the information acquiring system and the information acquiring apparatus (the information acquiring method) by reading the information-gathering computer program from the recording media and executing the information-gathering computer program. The apparatus that executes the information-gathering computer program according to the present invention is not be limited to the computer system 100 but may be other computer systems such as the computer system 111, the server 112, and any combinations of the computer system 100, the computer system 111, and the server 112.

The present invention is not limited to the first embodiment and the second embodiment, but may have other embodiments as far as the embodiments are within the scope of the technical idea described in the scope of claims.

For example, in the first embodiment and the second embodiment, the generation information of the web-page that the user refers to is configured by receiving and holding the generation information as shown in FIG. 6. However, the present invention is not to be thus limited and may have other embodiments as far as the user can configure the generation information to be referred at user's discretion.

Moreover, in this embodiment, when the web-page acquiring request is issued to the web-archiving server 20, when the web archive 22b does not include the web-page that has the URL and the gathering date that are same as the web-page corresponding to the web-page acquiring request, the information that indicates the web-page corresponding to the web-page acquiring request is not stored in the web archive 22b is output. However, the present invention is not to be thus limited, and the generation list of the web-page that has the same URL and the different gathering date may be received from the web archive 22b and output. Consequently, even if the web archive 22b does not include the intended web-page with the intended generation, the information that has the certain validity with respect to the user's intended information can be provided.

Moreover, the operations that are performed automatically in the first embodiment and the second embodiment may be performed manually and the operations that are performed manually in the first embodiment and the second embodiment may be performed automatically in the conventional way. The information, such as the various operations, the assigned names, the various types of data and parameters, are variable as far as the information is not specified.

Moreover, the configurations of each apparatus are shown in the accompanying diagrams from a functional viewpoint, and each apparatus does not have to be configured to be the same physically. Each apparatus is not limited to have the configuration shown and may be separated or integrated physically and functionally based on the load and the usage of each apparatus. Moreover, the operations performed on each apparatus are realized by the CPU or the wired logic (hardware).

In the information-acquiring computer program according to the present invention,
1) the search or the browsing of the intended web-page is performed by issuing the request for acquiring the information to the web archive;
2) after the web-page is specified in the result of the search or the browsing, the web-page is being referred, and the address of the web-archiving server is embedded in the URL of the linked web-page specified in the web-page that is being referred; and
3) the linked web-page is acquired from the web archive by issuing the request for acquiring the linked web-page based on the address of the web-archiving server.

Consequently, the information-acquiring computer program that issues the request for acquiring the web-page to the web archive of the web-archiving server and follows the links that exist in various types of web-pages stored in the web archive without rewriting the address the linked web-pages that the web-pages stored in the web archive include can be acquired.

Furthermore, in the information-acquiring computer program according to the present invention,
1) the web archive stores the web-page while correlating the address of the web-page with the generation information of the web-page;
2) when the search or the browsing of the intended web-page is performed, the generation information of the web-page specified in the result of the search or the browsing is acquired from the web archive and held; and
3) the request is issued to the web-archiving server to acquire the web-page and the generation information of the web-page.

Consequently, the information-acquiring computer program that precisely follows the links that exist in various types of web-pages stored in the web archive, and the generation information of the web-page that the user refers to can be configured automatically.

Moreover, in the information-acquiring computer program according to the present invention, the gathering date of the web-page is held as the generation information. Consequently, the information-acquiring computer program that specifies and acquires the intended web-page precisely can be acquired.

Furthermore, in the information-acquiring computer program according to the present invention, when the request for acquiring the web-page is issued to the web-archiving server and the web archive does not include the web-page that has the address and the generation information that are same as those of the web-page corresponding to the request, the generation information of the web-page, which has the address that is same as the web-page corresponding to the request and the generation information that is different from the web-page corresponding to the request, is acquired. Consequently, even if the web archive does not include the intended web-page with the intended generation, the information that has the certain validity with respect to the user's intended information can be provided.

Moreover, in the information-acquiring method according to the present invention,
1) the search or the browsing of the intended web-page is performed by issuing the request for acquiring the information to the web archive;
2) after the web-page is specified in the result of the search or the browsing, the web-page is being referred, and the address of the web-archiving server is embedded in the URL of the linked web-page specified in the web-page that is being referred; and
3) the linked web-page is acquired from the web archive by issuing the request for acquiring the linked web-page based on the address of the web-archiving server.

Consequently, the information-acquiring method that issues the request for acquiring the web-page to the web archive of the web-archiving server and follows the links that exist in various types of web-pages stored in the web archive without rewriting the address the linked web-pages that the web-pages stored in the web archive include can be acquired.

Furthermore, in the information-acquiring method according to the present invention,
1) the web archive stores the web-page while correlating the address of the web-page with the generation information of the web-page;
2) when the search or the browsing of the intended web-page is performed, the generation information of the web-page specified in the result of the search or the browsing is acquired from the web archive and held; and
3) the request is issued to the web-archiving server to acquire the web-page and the generation information of the web-page.

Consequently, the information-acquiring method that precisely follows the links that exist in various types of web-pages stored in the web archive, and the generation information of the web-page that the user refers to can be configured automatically.

Moreover, in the information-acquiring apparatus according to the present invention, the gathering date of the web-page is held as the generation information. Consequently, the information-acquiring apparatus that specifies and acquires the intended web-page precisely can be acquired.

Furthermore, in the information-acquiring apparatus according to the present invention, when the request for acquiring the web-page is issued to the web-archiving server and the web archive does not include the web-page that has the address and the generation information that are same as those of the web-page corresponding to the request, the generation information of the web-page, which has the address that is same as the web-page corresponding to the request and the generation information that is different from the web-page corresponding to the request, is acquired. Consequently, even if the web archive does not include the intended web-page with the intended generation, the information that has the certain validity with respect to the user's intended information can be provided.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. An information-acquiring apparatus comprising:
a search unit that performs search or browsing of a first web-page by issuing a request for acquiring information to a web archive;
an embedding unit that embeds an address of a web-archiving server having the web archive in a uniform resource locator of a linked web-page specified in the first web-page; and
an acquiring unit that acquires the linked web-page from the web archive by issuing a request for acquiring the linked web-page to the web-archiving server based on the address.

2. The information-acquiring apparatus according to claim 1, further comprising a holding unit that holds a generation information of the first web-page by acquiring the generation information from the web archive when performing search or browsing, wherein
the web archive stores the first web-page with an address and a generation information corresponding to the first web-page, and
the acquiring unit acquires a generation information of the first web-page when issuing the request.

3. An information-acquiring method comprising:
performing search or browsing of a first web-page by issuing a request for acquiring information to a web archive;
embedding an address of a web-archiving server having the web archive in a uniform resource locator of a linked web-page specified in the first web-page; and
acquiring the linked web-page from the web archive by issuing a request for acquiring the linked web-page to the web-archiving server based on the address.

4. The information-acquiring method, according to claim 3, further comprising holding a generation information of the first web-page by acquiring the generation information from the web archive when performing search or browsing, wherein
the web archive stores the first web-page with an address and a generation information corresponding to the first web-page, and
the acquiring includes acquiring a generation information of the first web-page when issuing the request.

5. A computer program for acquiring information, making a computer execute the steps comprising:
performing search or browsing of a first web-page by issuing a request for acquiring information to a web archive;
embedding an address of a web-archiving server having the web archive in a uniform resource locator of a linked web-page specified in the first web-page; and
acquiring the linked web-page from the web archive by issuing a request for acquiring the linked web-page to the web-archiving server based on the address.

6. The computer program according to claim 5, further making the computer execute holding a generation information of the first web-page by acquiring the generation information from the web archive when performing search or browsing, wherein
the web archive stores the first web-page with an address and a generation information corresponding to the first web-page, and
the acquiring includes acquiring a generation information of the first web-page when issuing the request.

7. The computer program according to claim 6, wherein the generation information includes date and time of gathering the first web-page.

8. The computer program according to claim 6, further making the computer execute acquiring a generation list of a second web-page that has different generation information with same address from the web archive, if the web archiving does not have the first web-page of the address and the generation information when performing the request.
